(19) United States
(12) Patent Application Publication
(10) Pub. No.: US 2018/0283095 A1
(43) Pub. Date: Oct. 4, 2018

(54) SAFETY LIFT CORD DEVICE FOR A WINDOW BLIND

(71) Applicant: YA-YIN LIN, CHIAYI CITY (TW)

(72) Inventor: YA-YIN LIN, CHIAYI CITY (TW)

(21) Appl. No.: 15/474,987

(22) Filed: Mar. 30, 2017

(51) Int. Cl. E06B 9/326

(52) U.S. Cl. CPC E06B 9/326

(57) ABSTRACT

A safety lift cord device includes a safety guard adapted to be attached to a blind shade of a window blind, and a lift cord extending vertically in a lengthwise direction in a cord running section of the guard. The cord running section has a plurality of guard units, each having first and second front segments which are disposed forwardly of and intersect the lift cord, and first and second rear segments which are disposed rearwardly of and intersect the lift cord such that a penetrating hole is defined among the segments. It is not feasible for a child to reach and pull the lift cord out from the penetrating holes.

### FIELD

The disclosure relates to a window blind, and more particularly to a roman blind having a safety lift cord device that is attached to extending pleats of a blind shade to be controlled for raising and lowering the shade.

BACKGROUND

A conventional window blind has two lift cords attached to a blind shade to be controlled for raising and lowering the blind shade. To prevent children from strangulation or suffocation accidents, referring to FIGS. 1 and 2, a roman shade 1 disclosed in U.S. Pat. No. 9,074,409 has a head rail 11, a blind shade 12 extending vertically from the head rail 11 to be movable between raised and lowered positions and having a plurality of extending pleats 121, and two lift cord assemblies 2 (only one is shown) mounted on a backside of the blind shade 12. Each lift cord assembly 2 has a lift cord 21 disposed vertically to move the shade 12, and a sleeve body 20 surrounding the lift cord 21. The sleeve body 20 is attached to the extending pleats 121, and has a first end rope 22, a second end rope 23 and a middle rope 24 parallel to each other. A cord running section 25 is defined between the first end rope 22 and the middle rope 24 such that the lift cord 21 is disposed in the cord running section 25. A plurality of connecting ropes 251, 252 extend horizontally to connect between the middle rope 24 and the first end rope 22. Each pair of connecting ropes 251, 252 are disposed forwardly and rearwardly of the lift cord 21 to form a loop such that the lift cord 21 is freely movable within the cord running section 25. However, a rectangular hole 26 defined between each two adjacent connecting ropes 251 is liable to cause a child's finger to reach and pull the lift cord 21 out, which results in the risk of endangering the child. Increment of the number of the connecting ropes 251, 252 would narrow the distance between the adjacent ropes 251, but a material cost must be relatively increased.

### SUMMARY

Therefore, an object of the disclosure is to provide a safety lift cord device for a window blind that can alleviate at least one of the drawbacks of the prior art.

According to the disclosure, the safety lift cord device includes a lift cord extending vertically in a lengthwise direction, and an elongated safety guard having a cord running section in which the lift cord is disposed. The cord running section has a plurality of guard units disposed in the lengthwise direction. Each of the guard units has a first front segment which is disposed forwardly of the lift cord and which extends in an increased slope direction that is inclined relative to both the lengthwise direction and a horizontal direction normal to the lengthwise direction, to intersect the lift cord, a second front segment which is disposed forwardly of the lift cord and which extends in a decreased slope direction that is inclined relative to both the lengthwise direction and the horizontal direction to intersect the lift cord, a first rear segment which is disposed rearwardly of the lift cord and which extends in the decreased slope direction to intersect the lift cord, and a second rear segment which is disposed rearwardly of the lift cord and which extends in the increased slope direction to intersect the lift cord. The cord running section has a plurality of penetrating holes each defined among the first and second front segments and the first and second rear segments such that it is not feasible for a child to reach and pull the lift cord out from the penetrating holes.

### BRIEF DESCRIPTION OF THE DRAWINGS

Other features and advantages of the disclosure will become apparent in the following detailed description of the embodiments with reference to the accompanying drawings, of which:

FIG. 1 is a fragmentary perspective view of a conventional window blind disclosed in U.S. Pat. No. 9,074,409;

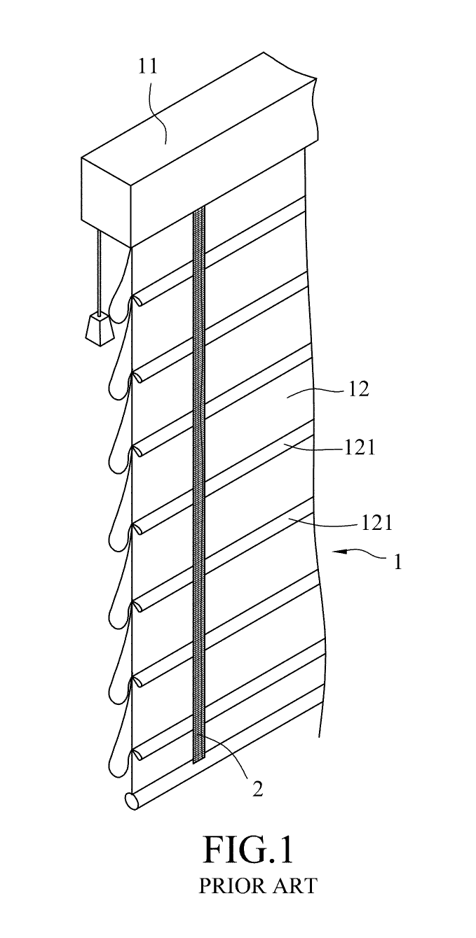

FIG. 2 is a fragmentary front view of a safety cord assembly of the conventional window blind in FIG. 1;

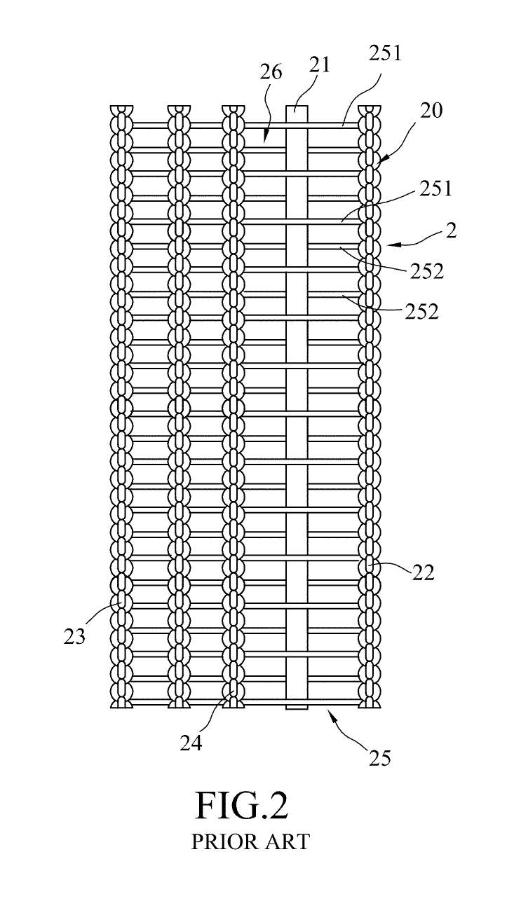

FIG. 3 is a fragmentary front view of an embodiment of a safety lift cord device according to the disclosure;

FIG. 4 is a schematic front view illustrating the safety lift cord device mounted on a window shade of a window blind; and

FIG. 5 is a fragmentary front view of another embodiment of a safety lift cord device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

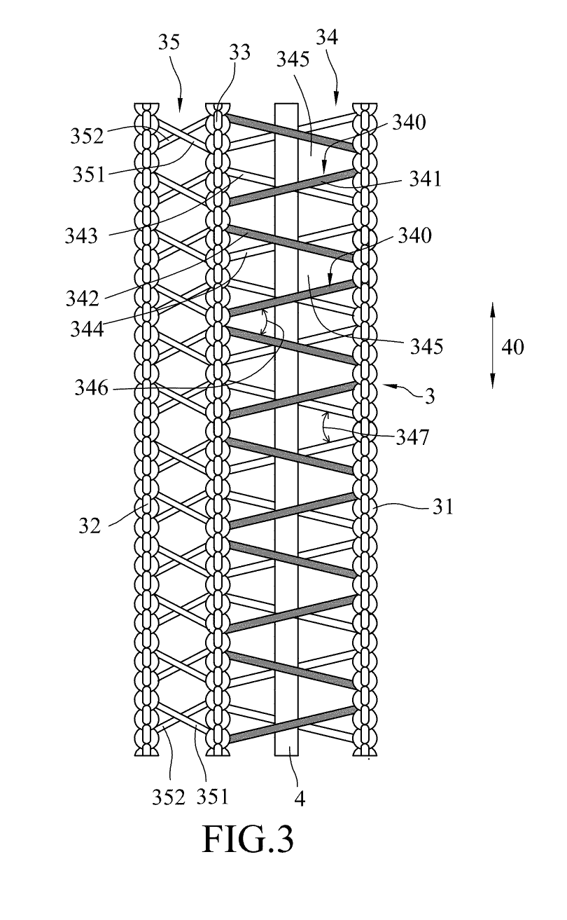

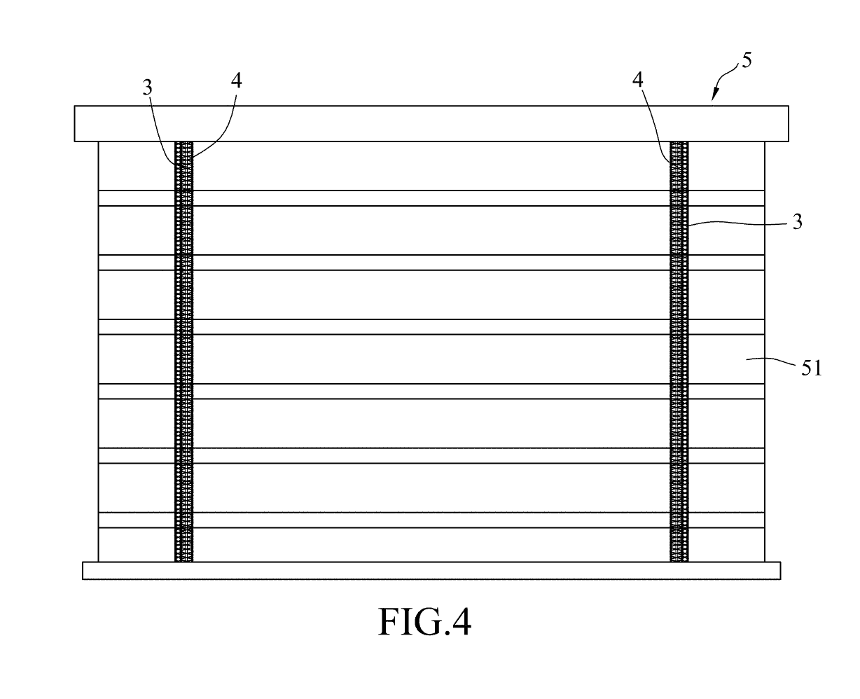

Referring to FIGS. 3 and 4, an embodiment of a safety lift cord device according to this disclosure is adapted to be mounted on a window blind 5 which has a blind shade 51 controlled to move vertically between raised and lowered positions. The safety lift cord device is made by way of weaving, and includes an elongated safety guard 3 with a web structure, and a lift cord 4 extending vertically in a lengthwise direction 40 to be controlled for raising and lowering the window shade 51.

The safety guard 3 has a chain-shaped first end rope 31, a chain-shaped second end rope 32 spaced apart from the first end rope 31 in a horizontal direction (i.e., a left-and-right direction) normal to the lengthwise direction, and a chain-shaped middle rope 33 interposed between the first and second end ropes 31, 32 and spaced apart from both the first and second end ropes 31, 32 in the horizontal direction. A cord running section 34 is disposed between the first end rope 31 and the middle rope 33 such that the lift cord 4 is disposed in the cord running section 34. A connecting section 35 is disposed between the middle rope 33 and the second end rope 32. Each of the first and second end ropes 31, 32 and the middle rope 33 is elongated in the lengthwise direction 40.

The cord running section 34 has a plurality of guard units 340 arranged and spaced apart from each other in the lengthwise direction. Each of the guard units 340 has a first front segment 341 which is disposed forwardly of the lift cord 4 and which extends in an increased slope direction that is inclined relative to both the lengthwise direction and the horizontal direction to intersect the lift cord 4, a second front segment 342 which is disposed forwardly of the lift cord 4 and which extends in a decreased slope direction that is inclined relative to both the lengthwise direction and the horizontal direction to intersect the lift cord 4, a first rear segment 343 which is disposed rearwardly of the lift cord 4 and which extends in the decreased slope direction to intersect both the lift cord 4 and the first front segment 341, and a second rear segment 344 which is disposed rearwardly of the lift cord 4 and which extends in the increased slope direction to intersect both the lift cord 4 and the second front segment 342. Thus, the cord running section 34 has a plurality of penetrating holes 345 each defined among the first and second front segments 341, 342 and the first and second rear segments 343, 344. In this embodiment, each penetrating hole 345 is of a substantially rhombus shape. Hence, the first and second front segments 341, 342 are extended in a zigzag way between the first end rope 31 and the middle rope 33, and the first and second rear segments 343, 344 are extended in a zigzag way between the first end rope 31 and the middle rope 33. The first and second front segments 341, 342 of each guard unit 340 have extending lines which intersect each other by a front included angle 346 that is smaller than 90 degrees. The first and second rear segments 343, 344 of each guard unit 340 have extending lines which intersect each other by a rear included angle 347 that is smaller than 90 degrees. For example, each of the front and rear included angles 346, 347 is about 30 degrees.

The connecting section 35 is attached to the blind shade 51. In this embodiment, the connecting section 35 has a plurality of first connecting segments 351 each of which is connected between the middle rope 33 and the second end rope 32 and extends in a decreased tilt direction that is inclined relative to both the lengthwise direction and the horizontal direction, and a plurality of second connecting segments 352 each of which is connected between the middle rope 33 and the second end rope 32 and extends in an increased tilt direction that is inclined relative to both the lengthwise direction and the horizontal direction to intersect the respective first connecting segment 351.

In use, the connecting section 35 is attached to the blind shade 51 at a plurality of attachment portions that are equivalently spaced apart from each other in the lengthwise direction 40, such as at the extending pleats of the roman-type blind shade 51. The lift cord 4 is disposed in the cord running section 34 in the lengthwise direction 40, and rearwardly of the first and second front segments 341, 342 and forwardly of the first and second rear segments 343, 344. Since each of the first and second front and rear segments 341, 342, 343, 344 is inclined relative to both the lengthwise direction 40 and the horizontal direction, each of the penetrating holes 345 defined thereamong is considerably reduced at its width. In other words, with the same largest height of the penetrating holes 345, the height of each penetrating hole 345 is reduced gradually toward two sides thereof. It is not feasible for a child to reach and pull the lift cord 4 out from any one of the penetrating holes 345, such that the risk of endangering children can be greatly reduced. Thus, the safety lift cord device according to the disclosure can prevent children from accidental strangulation without the need to increase the guard units 340.

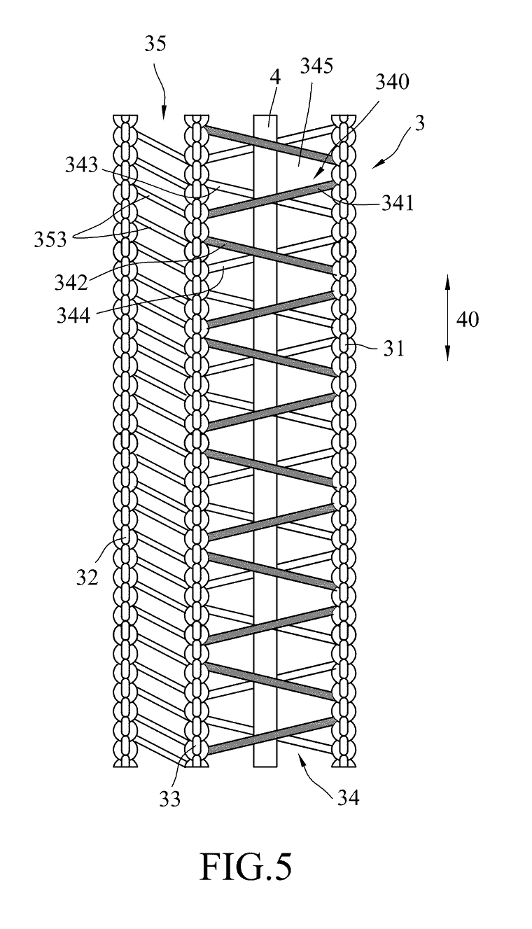

Referring to FIG. 5, in another embodiment, the connecting section 35 of the safety guard 3 has a plurality of connecting segments 353 which are connected between the middle rope 33 and the second end rope 32 and which extend parallel to each other. Each of the connecting segments 353 extends in a slope direction that is inclined relative to both the lengthwise direction 40 and the horizontal direction.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A safety lift cord device for a window blind, comprising:
a lift cord extending vertically in a lengthwise direction; and
an elongated safety guard having a cord running section in which said lift cord is disposed, and which has a plurality of guard units disposed in the lengthwise direction, each of said guard units having a first front segment which is disposed forwardly of said lift cord and which extends in an increased slope direction that is inclined relative to both the lengthwise direction and a horizontal direction normal to the lengthwise direction, to intersect said lift cord, a second front segment which is disposed forwardly of said lift cord and which extends in a decreased slope direction that is inclined relative to both the lengthwise direction and the horizontal direction to intersect said lift cord, a first rear segment which is disposed rearwardly of said lift cord and which extends in the decreased slope direction to intersect said lift cord, and a second rear segment which is disposed rearwardly of said lift cord and which extends in the increased slope direction to intersect said lift cord, said cord running section having a plurality of penetrating holes each defined among said first and second front segments and said first and second rear segments.

2. The safety lift cord device as claimed in claim 1, wherein said first and second front segments of each of said guard units have extending lines which intersect each other by a front included angle smaller than 90 degrees.

3. The safety lift cord device as claimed in claim 2, wherein said first and second rear segments of each of said guard units have extending lines which intersect each other by a rear included angle smaller than 90 degrees

4. The safety lift cord device as claimed in claim 1, wherein said safety guard has a first end rope, a second end rope spaced apart from said first end rope in the horizontal direction, and a middle rope interposed between said first and second end ropes and spaced apart from both said first and second end ropes in the horizontal direction, said cord running section being disposed between said first end rope and said middle rope.

5. The safety lift cord device as claimed in claim 4, wherein said safety guard has a connecting section which is disposed between said middle rope and said second end rope.

6. The safety lift cord device as claimed in claim 5, wherein said connecting section has a plurality of first connecting segments each of which is connected between said middle rope and said second end rope and extends in a decreased tilt direction that is inclined relative to both the lengthwise direction and the horizontal direction, and a plurality of second connecting segments each of which is connected between said middle rope and said second end rope and extends in an increased tilt direction that is inclined relative to both the lengthwise direction and the horizontal direction to intersect a respective one of said first connecting segments.

7. The safety lift cord device as claimed in claim 5, wherein said connecting section has a plurality of connecting segments which are connected between said middle rope and said second end rope and which extend parallel to each other.

8. The safety lift cord device as claimed in claim 7, wherein each of said connecting segments extends in a slope direction that is inclined relative to both the lengthwise direction and the horizontal direction.
